(19) United States
(12) Patent Application Publication
(10) Pub. No.: US 2025/0197779 A1
(43) Pub. Date: Jun. 19, 2025

(54) WATER-SOLUBLE UNIT DOSE ARTICLE CONTAINING A CORE/SHELL CAPSULE

(71) Applicant: The Procter & Gamble Company, Cincinnati, OH (US)

(72) Inventors: Mattia COLLU, Saint-Gilles (BE); Julien Christian LABIE, Waterloo (BE); Laura ORLANDINI, Le Mont-Sur-Lausanne (CH); Pieter Jan Maria SAVEYN, Destelbergen (BE); Johan SMETS, Lubbeek (BE); Cédric Marc TAHON, Oost-Vlaanderen (BE); Pierre Daniel VERSTRAETE, Woluwe Saint Lambert (BE); Wouter WALRAVENS, Humbeek (BE); Travis Ian BARDSLEY, Appleton, WI (US); Sonia Marcela MALAGON GOMEZ, Appleton, WI (US); Linsheng FENG, Menasha, WI (US); Dominick Joseph VALENTI, Moore, SC (US)

(21) Appl. No.: 18/969,361

(22) Filed: Dec. 5, 2024

Related U.S. Application Data
(60) Provisional application No. 63/609,380, filed on Dec. 13, 2023.

(51) Int. Cl. C11D 3/50; C11D 17/04

(52) U.S. Cl. CPC C11D 3/505; C11D 17/043; C11D 2111/12

(57) ABSTRACT

Water-soluble unit dose article containing a laundry detergent composition containing a capsule having a core and a shell.

### FIELD OF THE INVENTION

Water-soluble unit dose article containing a laundry detergent composition containing a capsule having a core and a shell.

### BACKGROUND OF THE INVENTION

Water-soluble unit dose articles are liked by consumers as they are convenient and efficient to use. Such water-soluble unit dose articles often comprise laundry detergent compositions. When the water-soluble unit dose article is added to water, the film dissolves/disintegrates releasing the internal contents into the surrounding water to create a wash liquor.

Often encapsulated perfumes are formulated into the detergent compositions of water-soluble unit dose articles to provide fabric freshness benefits. These encapsulated perfumes comprise a core comprising perfume surrounded by a shell. Whilst such encapsulates are well suited for delivering perfumes through the wash operation on fabrics, it was found that when formulated into water-soluble unit dose articles comprising a detergent composition enclosed into a water-soluble film, there was lower than desired consumer noticeable freshness benefits on fabrics following the wash operation. Such encapsulates have also been found to leak perfume when formulated in surfactant comprising formulations, especially when formulated in low water surfactant comprising formulations. Perfume leakage can compromise freshness delivery onto fabrics, as well as potentially causing some product discoloration when perfume raw materials react with other components formulated in the detergent formulation such as amines.

Typically perfume capsule technologies comprise a high petrochemically derived content. Perfume capsules with reduced petrochemically derived content have also been described, including capsules based on the reaction product of chitosan with a single isocyanate based cross-linking agent. Such perfume capsules have been found to be very sensitive to perfume leakage within low water surfactant comprising water-soluble unit dose detergent formulations.

Thus, the objective of the present invention is to provide perfume capsules with reduced petrochemically derived content that are less sensitive to leakage when formulated within a low water surfactant comprising detergent formulation, and which are capable of providing improved freshness benefits on fabrics during and after the wash operation when formulated in a water-soluble unit dose detergent composition enclosed in a water-soluble film.

It was surprisingly found that when formulating a laundry detergent composition comprising perfume capsules with reduced petrochemical content according to the invention, wherein the laundry detergent composition is enclosed inside a water-soluble film, a significantly improved fabric freshness performance was obtained.

### SUMMARY OF THE INVENTION

An aspect of the invention is a water-soluble unit dose article, wherein the water-soluble unit dose article comprises a water-soluble film, preferably a polyvinyl alcohol film and a laundry detergent composition, wherein the water-soluble film encloses the laundry detergent composition, wherein the laundry detergent composition comprises capsules, wherein the capsules have a core and a shell and wherein the shell surrounds the core; wherein the core comprises a perfume,
wherein the shell comprises a polymeric material that is the reaction product of chitosan, preferably derived from an aqueous phase, and a cross-linking agent, preferably derived from an oil phase, wherein the cross-linking agent comprises an isocyanate component, the isocyanate component comprising a mixture of two or more di- and/or poly-isocyanates, the di- and/or poly-isocyanates each comprising an aromatic moiety; and,
wherein the mixture of di- and/or poly-isocyanates comprising an aromatic moiety comprises at least one alpha-aromatic isocyanate and at least one beta-aromatic isocyanate,
preferably, wherein the required at least one alpha- and at least one beta-aromatic isocyanates are each present in at least 20 mole percent of the total isocyanate component.

It was surprisingly found that by incorporating a mixture of di- and/or poly-isocyanates comprising at least one alpha-aromatic isocyanate and at least one beta-aromatic isocyanate in the shell resulted in capsules that exhibited reduced leakage as well as improved freshness benefits on fabrics when said fabrics were treated through the wash using a unit-dose article according to the present invention.

### DETAILED DESCRIPTION OF THE INVENTION

### Water-Soluble Unit Dose Article

The present invention relates to a water-soluble unit dose article comprising a water-soluble film, preferably a polyvinyl alcohol film, and a laundry detergent composition, wherein the water-soluble film encloses the laundry detergent composition. The water-soluble film, preferably water-soluble polyvinyl alcohol film, and the laundry detergent composition are both described in more detail below.

The water-soluble unit dose article comprises the water-soluble film, preferably a water-soluble polyvinyl alcohol film, shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article will comprise at least three films, top, one or more middle, and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side. The unit dose article may comprise at least four compartments, three of the compartments may be smaller than the fourth compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments, or even in four compartments.

Each compartment may comprise the same or different compositions. The different compositions could all be in the same form, or they may be in different forms. The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

Without wishing to be bound by theory, it is believed there is a synergistic effect between the water-soluble polymer in the water-soluble film, especially the polyvinyl alcohol polymer in the water-soluble film, and perfume capsules according to the present invention. This synergistic effect results in improved capsule deposition and retention onto fabrics during the wash and an overall improved fabric freshness performance accordingly.

This is even more surprising considering petrochemically derived encapsulated perfumes were found to negatively interact with the water-soluble polymer in the water-soluble film, especially the polyvinyl alcohol polymer in the water-soluble film, leading to a fabric freshness compromise.

The perfume capsules of the present disclosure have also been found to provide better fabric freshness performance and improved leakage prevention relative to alike perfume compositions solely comprising a single isocyanate based cross-linking agent as known in the art, even when being formulated within a low-water surfactant-comprising detergent composition enclosed in a water-soluble film. An improved detergent product colour stability profile has also been obtained through use of perfume capsules according to the present disclosure.

### Water-Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns: 5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

The water-soluble film preferably comprises polyvinyl alcohol. Preferably, the water-soluble film comprises at least 50%, preferably at least 60%, by weight of the water-soluble film of polyvinyl alcohol. The water-soluble film may comprise between 50% and 100%, or even between 60% and 99%, even more preferably between 60% and 80%, by weight of the water-soluble film of polyvinyl alcohol.

Preferably, the water-soluble film comprises a polyvinyl alcohol selected from a polyvinyl alcohol homopolymer or a polyvinyl alcohol copolymer, or a blend thereof, preferably a blend of polyvinylalcohol homopolymers and/or polyvinylalcohol copolymers, preferably wherein the polyvinyl alcohol copolymers are selected from sulphonated and carboxylated anionic polyvinylalcohol copolymers especially carboxylated anionic polyvinylalcohol copolymers, most preferably wherein the polyvinyl alcohol comprises a blend of a polyvinylalcohol homopolymer and a carboxylated anionic polyvinylalcohol copolymer, or a blend of polyvinyl alcohol homopolymers. Alternatively, the water-soluble film comprises a single carboxylated polyvinyl alcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

Preferably, the water-soluble film, and each individual component thereof, independently comprises between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppb and 100 ppb, most preferably 0 ppb dioxane. Those skilled in the art will be aware of known methods and techniques to determine the dioxane level within water-soluble films and ingredients thereof.

### Laundry Detergent Composition

The laundry detergent composition may be any suitable composition. The composition may be in the form of a solid, a liquid, or a mixture thereof. Preferably the composition is a liquid composition.

A solid can be in the form of free-flowing particulates, compacted solids or a mixture thereof. It should be understood, that a solid may comprise some water, but is essentially free of water. In other words, no water is intentionally added other than what comes from the addition of various raw materials.

In relation to the laundry detergent composition of the present invention, the term ‘liquid’ encompasses forms such as dispersions, gels, pastes and the like. The liquid composition may also include gases in suitably subdivided form. The term ‘liquid laundry detergent composition’ refers to any laundry detergent composition comprising a liquid capable of wetting and treating fabric e.g., cleaning clothing in a domestic washing machine. A dispersion for example is a liquid comprising solid or particulate matter contained therein.

The laundry detergent composition can be used as a fully formulated consumer product or may be added to one or more further ingredient to form a fully formulated consumer product. The laundry detergent composition may be a ‘pre-treat’ composition which is added to a fabric, preferably a fabric stain, ahead of the fabric being added to a wash liquor.

The laundry detergent composition comprises capsules and said capsules are described in more detail below.

Preferably, the laundry detergent composition comprises a non-soap surfactant. The non-soap surfactant is preferably selected from non-soap anionic surfactant, non-ionic surfactant or a mixture thereof. Preferably, the laundry detergent composition comprises between 10% and 60%, more preferably between 20% and 55% by weight of the laundry detergent composition of the non-soap surfactant.

Preferably, the anionic non-soap surfactant comprises linear alkylbenzene sulphonate, alkyl sulphate, alkoxylated alkyl sulphate, or a mixture thereof. Preferably, the alkoxylated alkyl sulphate is an ethoxylated alkyl sulphate.

Preferably, the laundry detergent composition comprises between 5% and 60%, preferably between 15% and 55%, more preferably between 25% and 50%, most preferably between 30% and 45% by weight of the detergent composition of the non-soap anionic surfactant.

Preferably, the non-soap anionic surfactant comprises linear alkylbenzene sulphonate and alkoxylated alkyl sulphate, wherein the ratio of linear alkylbenzene sulphonate to alkoxylated alkyl sulphate preferably the weight ratio of linear alkylbenzene sulphonate to ethoxylated alkyl sulphate is from 1:10 to 10:1, preferably from 6:1 to 1:6, more preferably from 4:1 to 1:4, even more preferably from 4:1 to 1:1. Alternatively the weight ratio of linear alkylbenzene sulphonate to ethoxylated alkyl sulphate is from 1:2 to 1:4. The alkoxylated alkyl sulphate can be derived from a synthetic alcohol or a natural alcohol, or from a blend thereof, pending the desired average alkyl carbon chain length and average degree of branching. Preferably, the synthetic alcohol is made following the Ziegler process, OXO-process, modified OXO-process, the Fischer Tropsch process, Guerbet process or a mixture thereof. Preferably, the naturally derived alcohol is derived from natural oils, preferably coconut oil, palm kernel oil or a mixture thereof.

Preferably, the laundry detergent composition comprises between 0% and 30%, preferably between 1% and 25%, more preferably between 3% and 20%, most preferably between 5% and 20% by weight of the laundry detergent composition of a non-ionic surfactant. Preferably the weight ratio of non-soap anionic surfactant to nonionic surfactant is from 1:2 to 20:1, from 1:1.5 to 15:1, from 1:1 to 10:1, or from 1.5:1 to 5:1. The non-ionic surfactant is preferably selected from alcohol alkoxylate non-ionic surfactant, including naturally derived alcohol, synthetic derived alcohol based alcohol alkoxylate non-ionic surfactants, and mixtures thereof, pending the desired average alkyl carbon chain length and average degree of branching. The alcohol alkoxylate nonionic surfactant can be a primary or a secondary alcohol alkoxylate nonionic surfactant, preferably a primary alcohol alkoxylate nonionic surfactant. Synthetically derived alcohol alkoxylate non-ionic surfactants include Ziegler-synthesized alcohol alkoxylate, an oxo-synthesized alcohol alkoxylate, a modified oxo-process synthesized alcohol alkoxylate, Fischer-Tropsch synthesized alcohol alkoxylates, Guerbet alcohol alkoxylates, alkyl phenol alcohol alkoxylates, or a mixture thereof. The alkoxylation chain can be a mixed alkoxylation chain comprising ethoxy, propoxy and/or butoxy units, or can be a purely ethoxylated alkyl chain, preferably a purely ethoxylated alkyl chain.

Preferably, the laundry preferably liquid laundry detergent composition comprises between 1% and 20%, more preferably between 2% and 15%, even more preferably between 3% and 10%, most preferably between 4% and 8% by weight of the laundry detergent composition of soap, preferably a fatty acid salt, more preferably an amine neutralized fatty acid salt, wherein preferably the amine is an alkanolamine more preferably selected from monoethanolamine, diethanolamine, triethanolamine or a mixture thereof, more preferably monoethanolamine.

Preferably, the laundry detergent composition comprises a non-aqueous solvent, preferably wherein the non-aqueous solvent is selected from ethanol, 1,2-propanediol, dipropylene glycol, tripropyleneglycol, glycerol, sorbitol, ethyleneglycol, polyethylene glycol, polypropylene glycol, or a mixture thereof, preferably wherein the polypropyleneglycol has a molecular weight of 400. Preferably the liquid laundry detergent composition comprises between 10% and 40%, preferably between 15% and 30% by weight of the liquid laundry detergent composition of the non-aqueous solvent. Without wishing to be bound by theory the non-aqueous solvents ensure appropriate levels of film plasticization so the film is not too brittle and not too ‘floppy’. Without wishing to be bound by theory, having the correct degree of plasticization will also facilitate film dissolution when exposed to water during the wash process.

Preferably, the liquid laundry detergent composition comprises between 1% and 20%, preferably between 5% and 15% by weight of the liquid laundry detergent composition of water.

Preferably, the laundry detergent composition comprises an ingredient selected from the list comprising cationic polymers, polyester terephthalate polymers, amphiphilic graft co-polymers, alkoxylated preferably ethoxylated polyethyleneimine polymers, carboxymethylcellulose, enzymes, bleach or a mixture thereof.

Preferably, the laundry detergent composition comprises non-encapsulated perfume.

The laundry detergent composition may comprise an adjunct ingredient, wherein the adjunct ingredient is selected from hueing dyes, aesthetic dyes, builders preferably citric acid, chelants, cleaning polymers, dispersants, dye transfer inhibitor polymers, fluorescent whitening agent, opacifier, antifoam, preservatives, anti-oxidants, or a mixture thereof. Preferably the chelant is selected from aminocarboxylate chelants, aminophosphonate chelants, or a mixture thereof.

Preferably, the laundry detergent composition has a pH between 6 and 10, more preferably between 6.5 and 8.9, most preferably between 7 and 8, wherein the pH of the laundry detergent composition is measured as a 10% dilution in demineralized water at 20° C.

The liquid laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition. When Newtonian the composition may have a viscosity value, at a shear rate of 20 s−1 and a temperature of 20° C., of 100 to 3,000 cP, alternatively 200 to 2,000 cP, alternatively 300 to 1,000 cP, following the method described herein. When non-Newtonian, the composition may have a high shear viscosity value, at a shear rate of 20 s−1 and a temperature of 20° C., of 100 to 3,000 cP, alternatively 300 to 2,000 cP, alternatively 500 to 1,000 cP, and a low shear viscosity value, at a shear rate of 1 s−1 and a temperature of 20° C., of 500 to 100,000 cP, alternatively 1000 to 10,000 cP, alternatively 1,300 to 5,000 cP, following the method described herein. Methods to measure viscosity are known in the art. According to the present disclosure, viscosity measurements are carried out using a rotational rheometer e.g. TA instruments AR550. The instrument includes a 40 mm 2° or 1° cone fixture with a gap of around 50-60μιη for isotropic liquids, or a 40 mm flat steel plate with a gap of 1000μιη for particles containing liquids. The measurement is carried out using a flow procedure that contains a conditioning step, a peak hold and a continuous ramp step. The conditioning step involves the setting of the measurement temperature at 20° C., a pre-shear of 10 seconds at a shear rate of 10 s1, and an equilibration of 60 seconds at the selected temperature. The peak hold involves applying a shear rate of 0.05 s1 at 20° C. for 3 min with sampling every 10 s. The continuous ramp step is performed at a shear rate from 0.1 to 1200 s1 for 3 min at 20° C. to obtain the full flow profile.

### Capsules

The laundry detergent composition comprises capsules. The capsules have a core and a shell. The shell surrounds the core.

The laundry detergent composition preferably comprises the capsules in an amount from 0.05% to 20%, more preferably from 0.05% to 10%, even more preferably from 0.1% to 5%, most preferably from 0.2% to 3%, by weight of the laundry detergent composition.

The core material comprises a perfume. The shell comprises a polymer. More particularly, the invention discloses a composition comprising a population of core-shell encapsulates (capsules), the core comprising a perfume. The shell is a polymeric material comprising the reaction product of a cross-linking agent preferably derived from an oil phase, and a chitosan preferably derived from a water phase. The cross-linking agent comprises a mixture of two or more di- and/or poly-isocyanates, the di- and/or poly-isocyanates each containing an aromatic moiety. Surprisingly, it has been found that leakage can be controlled as a function of two isocyanates, each comprising at least one aromatic moiety, which when combined with chitosan yield a low leakage capsule in different matrices and carriers, to an extent heretofore unachieved with degradable constructs. More particularly the cross-linking agent comprises an isocyanate component, wherein the isocyanate component comprises a mixture of two or more di- and/or poly-isocyanates, derived from an oil phase, the di- and/or poly-isocyanates each comprising an aromatic moiety; and each isocyanate is independently selected from the group consisting of an alpha-aromatic isocyanate and a beta-aromatic isocyanate. The mixture of di- and/or poly-isocyanates comprises at least one alpha-aromatic isocyanate and at least one beta-aromatic isocyanate.

Enhanced performance in terms of lower leakage and retention of core material in carrier material is surprisingly obtainable wherein the weighted % NCO groups of the aromatic isocyanate of the isocyanate component is from 15 to 32% or even from 20 to 26%, or even from 20 to 25% by weight, or even from 21 to 25% by weight of the isocyanate component.

Preferably, at least 21 wt % of the shell comprises chitosan. The isocyanate component may comprise methylenediphenyl isocyanate and xylylene diisocyanate in a weight ratio of from 1:2 to 1:1.75. The isocyanate component may comprise by weight 30 to 40% methylenediphenyl isocyanate and from 60 to 70% xylylene diisocyanate.

The shell comprises a polymeric material that is the reaction product of chitosan derived from an aqueous phase, and a cross-linking agent, derived from an oil phase, comprising an isocyanate component comprising a mixture of two or more di- and/or poly-isocyanates, the di- and/or poly-isocyanates each comprising an aromatic moiety. The isocyanates are di-isocyanates, tri-isocyanates or a mixture of di- and tri-isocyanates.

Surprisingly, low leakage can be achieved with careful selection of a mixture of di- and/or poly-isocyanates, comprising at least one alpha-aromatic isocyanate and at least one beta-aromatic isocyanate. Surprisingly, low leakage into carrier material is seen when the weighted % NCO groups of the aromatic isocyanate of the isocyanate component is from 15 to 32% or even from 20 to 26%, or even from 20 to 25% by weight, or even from 21 to 25% by weight. In particular, the compositions of the invention comprise an isocyanate component comprising an alpha- and beta-aromatic isocyanate. The alpha-aromatic isocyanate can be selected from the group consisting of:

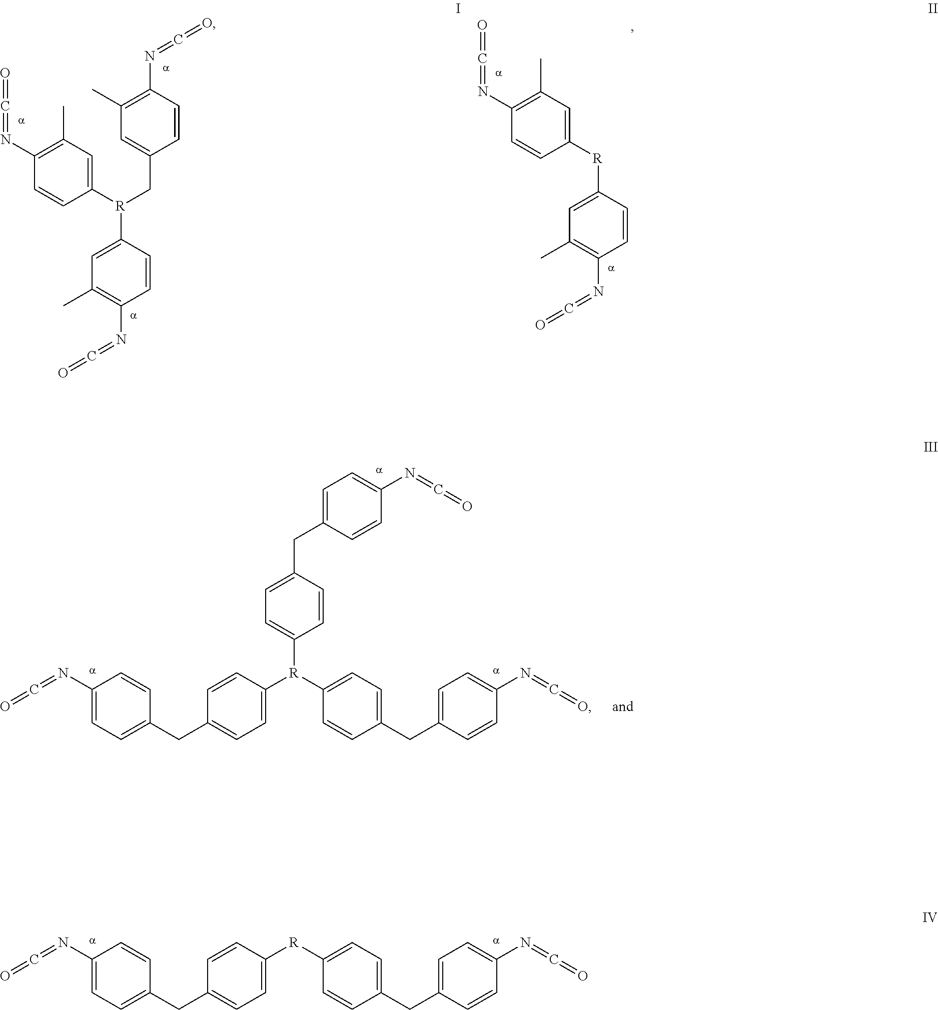

wherein R is a polyol having a pendant urethane group, a polyamine having a urea pendant group, a polyacid with an anhydrate group, a poly-isocyanate comprising a biuret, a poly-isocyanate comprising a uretdione, or a polyisocyanate comprising an isocyanurate.

R bonds to the above structures via at least two reactive moieties comprising for example an amine group, a hydroxy group, an anhydrate and similar groups that can bond into the listed structure.

R in structures I, II, III and IV and XII and XIII for example comprises moieties with at least two or more functional groups that link into the respective di- or tri-isocyanate. R in structures I, II, III and IV and XII and XIII for example can comprise polyol, or a polyol having one or more pendant urethane groups, or a polyamine, such as a polyamine having one or more urea pendant groups or other linking groups, a polyacid with an anhydrate group, a poly-isocyanate comprising a biuret, a poly-isocyanate comprising a uretdione, or a polyisocyanate comprising an isocyanurate. In structures I, II, III and IV and XII and XIII for example the R moieties include at least two or more functional groups that link into the respective di- or tri-isocyanate.

The aromatic isocyanates of formulas I-XVI are based on derivative variations of generally commercially available isocyanates such as xylylene diisocyanate (XDI), toluene diisocyanate (TDI) and methylene diphenyl diisocyanates (MDI).

The above selected aromatic isocyanates are generally available commercially. For example, Covestro in Leverkusen, Germany is a supplier of polyisocyanates and prepolymers under the Desmodur brand. Polyisocyanates conforming to the structures I-XVI disclosed herein are available under the Desmodur E brand of isocyanates and prepolymers, and/or can also be derived synthetically. Optionally aromatic isocyanates are also commercially available from sources such as Mitsui Chemicals, Inc., Tokyo, Japan such as the Takenate brand of isocyanates, e.g., Takenate D-110N adducts based on xylylene diisocyanate.

Specific examples of alpha-aromatic isocyanates useful in the invention can be selected from the group consisting of:

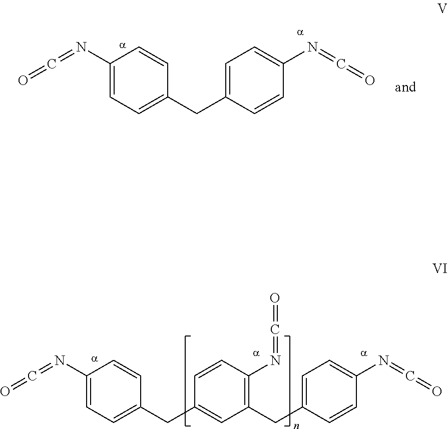

wherein n is an integer from 1 to 24, preferably from 1 to 18, or even from 1 to 12, or even from 1 to 8,

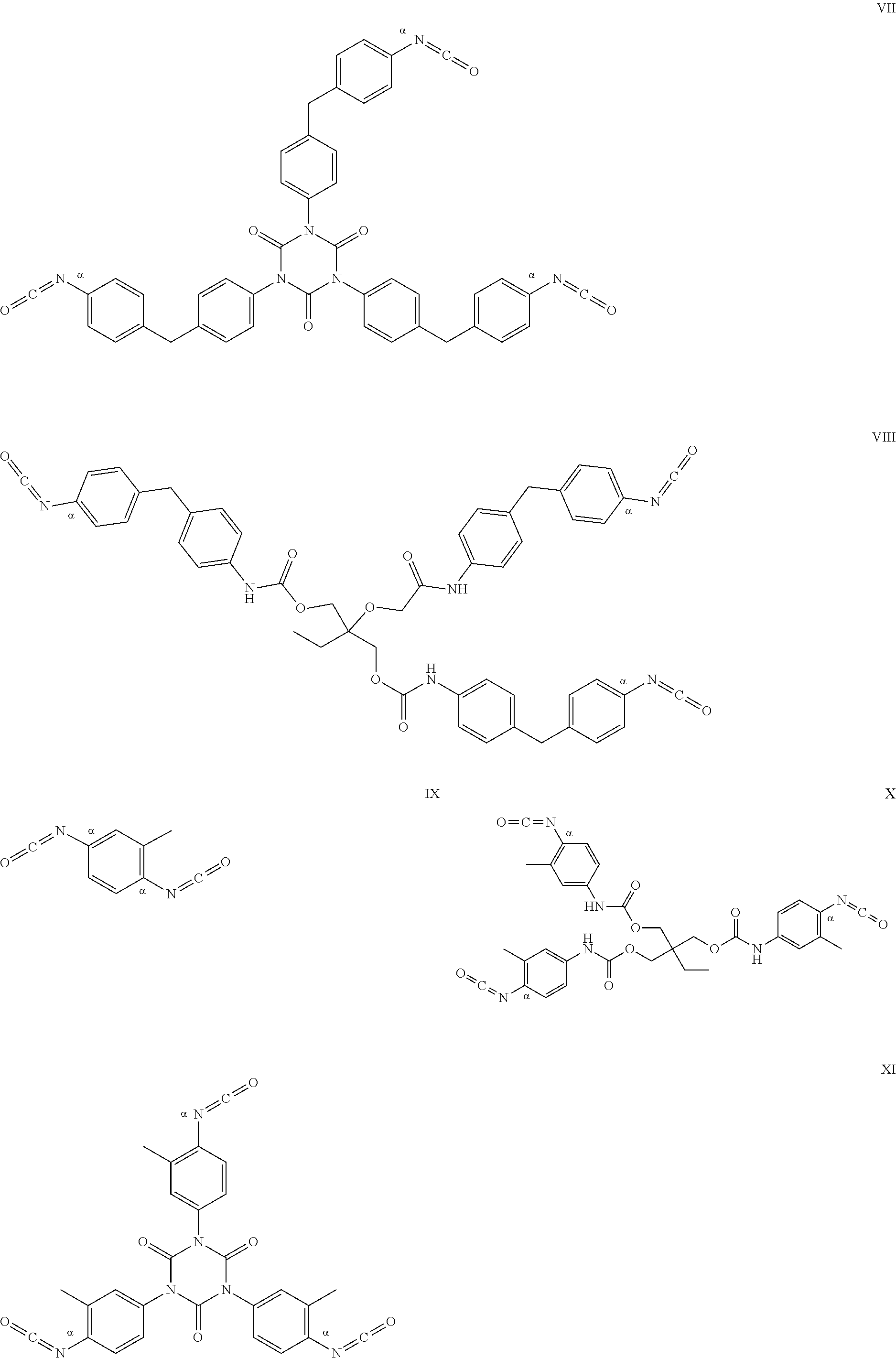 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; Cc1cc(N=C=O)ccc1N=C=O ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]

The beta-aromatic isocyanate useful in the invention can be selected from the group consisting of:

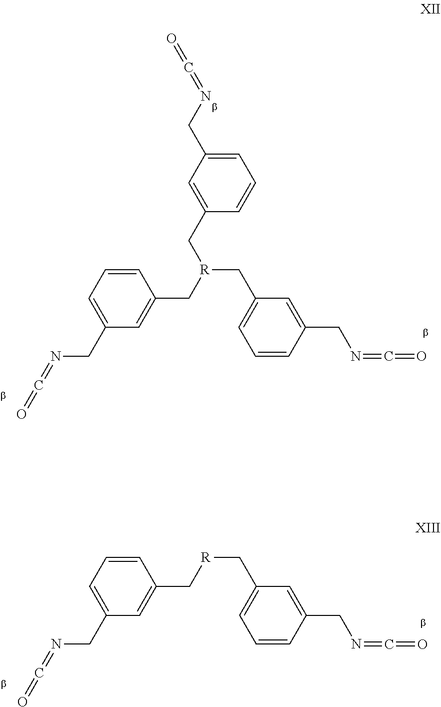

wherein R is a polyol having a pendant urethane group, a polyamine having a urea pendant group, a polyacid with an anhydrate group, a poly-isocyanate comprising a biuret, a poly-isocyanate comprising a uretdione, a polyisocyanate comprising an isocyanurate.

The alpha-aromatic isocyanate can also be selected from the group consisting of toluene diisocyanate, methylene diphenyl diisocyanate, polymeric methylene diphenyl diisocyanate, naphthalene diisocyanate, phenylene diisocyanate, isomers thereof, adducts thereof, and combinations thereof, and preferably selected from methylene diphenyl diisocyanate, polymeric methylene diphenyl diisocyanate, isomers thereof, adducts thereof, and combinations thereof.

Specific examples of beta-aromatic isocyanates useful in the invention can be selected from the group consisting of:

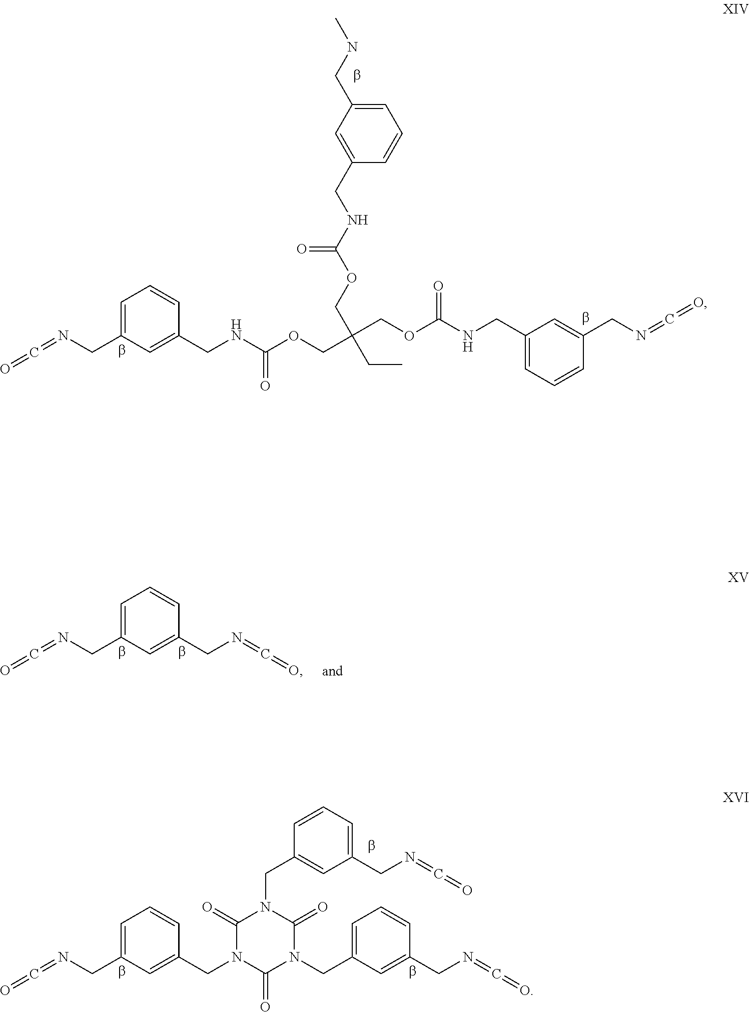 [SMILES: CCC(COC(=O)NCc1cccc(CN=C=O)c1)(COC(=O)NCc1cccc(CN=C=O)c1)COC(=O)NCc1cccc(CNC)c1 ; O=C=NCc1cccc(CN=C=O)c1 ; "and" ; O=C=NCc1cccc(Cn2c(=O)n(Cc3cccc(CN=C=O)c3)c(=O)n(Cc3cccc(CN=C=O)c3)c2=O)c1]

The beta-aromatic isocyanate can also be selected from the group consisting of xylylene diisocyanate, trimethylolpropane adducts of xylylene diisocyanate, tetramethylxylidene diisocyanate, isomers thereof, adducts thereof, and combinations thereof.

The isocyanate component can comprise at least two di- and/or poly-isocyanates selected from methylene diphenyl diisocyanate and xylylene diisocyanate. The xylylene diisocyanate may comprise a trimethylol propane-adduct of xylylene diisocyanate. the methylene diphenyl diisocyanate can be selected from 2,2′-methylenediphenyl diisocyanate and 4,4′-methylenediphenyl diisocyanate. Preferably the isocyanate components are in a weight ratio of from 1:2 to 1:1.75. Desirably the isocyanate component comprises by weight 30 to 40% of a methylene diphenyl diisocyanate and from 60 to 70% of a xylylene diisocyanate. Usefully, the isocyanate component comprises by weight about 34% methylene diphenyl diisocyanate and about 66% xylylene diisocyanate. Chitosan in combination with the isocyanate component within this isocyanate range or ratio surprisingly is able to efficiently deliver benefit agent at desired touchpoints. Leakage into matrix components and/or carriers is surprisingly reduced as a function of the combination with two isocyanates with the chitosan. The mixture of isocyanates having an aromatic moiety for example can comprise for example trimers of xylylene diisocyanate (XDI) or oligomers or pre-polymers of methylene diphenyl diisocyanate (MDI).

The di- and/or poly-isocyanates comprise an aromatic moiety. The isocyanates employed have two functional groups: an isocyanate group and an aromatic moiety. For ease of reference, the isocyanate molecules can be subdivided into several classifications.

A first grouping can be on the basis of the presence or absence of an aromatic moiety within the whole molecule; hence the following two classification are defined:
1—isocyanate comprising at least one aromatic moiety.
2—isocyanate not comprising any aromatic moiety.

For convenience, the presence of the aromatic moiety can be further classified as either alpha or beta based on carbon-atom naming. Hence the isocyanate comprising an aromatic moiety can be subdivided.
1. i) isocyanate comprising an alpha-aromatic moiety; and,
1. ii) isocyanate comprising a beta-aromatic moiety.
   For ease of reference, Group 1, i) and ii) classifications are then referred to as:
1. i) alpha-aromatic
1. ii) beta-aromatic
and Group 2 as
2. “non-aromatic”

Optionally, prior to shell formation, the chitosan used to make the shells can be treated such with acid, or even a mixture of acids or with a redox initiator preferably persulfate. The redox initiator is selected from any of persulfate or a peroxide. Preferably, the redox initiator is selected from the group consisting of ammonium persulfate, sodium persulfate, potassium persulfate, cesium persulfate, benzoyl peroxide, hydrogen peroxide, and mixtures thereof.

Typically, when chitosan is dissolved in water, for example during the process of making capsules, the resulting mixture tends to be quite viscous. This can result in flowability and processing challenges, and/or inhibit the adequate formation of shells. Acid treatment can result in a decrease of the mixture's viscosity and an improved shell structure. Additionally, it is believed that acid treating the chitosan can beneficially affect the molecular weight of the chitosan, thereby leading to improved shell formation and/or delivery performance.

Without wishing to be bound by theory, it is believed that careful selection of the chitosan and isocyanate combination within the weight ratios of the invention is advantageous in surprisingly achieving a long shelf-life composition containing capsules. For example, selection of an isocyanate component according to the invention results in capsules that perform better at certain touchpoints. It is believed that the combination of isocyanates of the invention yields a higher density capsule. It is believed that the surprising effect of reduced leakage is attributable to not only density of the polymeric material but also related to the presence of aromatic moieties in combination with the reactive sites of the isocyanate component.

Without wishing to be bound by theory, it is believed that careful selection of the chitosan's molecular weight can be advantageous. For example, selection of a chitosan having a molecular weight above a certain threshold can result in capsules that perform better at certain touchpoints compared to particles made from chitosan of a lower molecular weight. Surprisingly treatment with acid can yield a chitosan at a 3.5% concentration, typically having a starting viscosity or approximately 4000 cP, displaying a viscosity reduction of 60% or even exceeding 60%, to a viscosity of 1500 cP, or even 1000 cP at the same concentration as compared to an untreated chitosan.

The chitosan is characterized by preferably a weight average molecular weight of from about 100 to about 800 kDa or even from 100 kDa to about 600 kDa. Preferably, the chitosan is characterized by a weight average molecular weight (Mw) of from about 100 kDa to about 500 kDa, preferably from about 100 kDa to about 400 kDa, more preferably from about 100 kDa to about 300 kDa, even more preferably from about 100 kDa to about 200 kDa. The method used to determine the chitosan's molecular weight and related parameters is provided in the Test Methods section below and uses gel permeation chromatograph with multi-angle light scatter and refractive index detection (GPC-MALS/RI) techniques. Selecting chitosan having the preferred weight average molecular weight can result in capsules having suitable shell formation and/or desirable processability. For clarity the chitosan weight average molecular weight is measured prior to treatment, such as with acid and/or redox initiator as herein described.

The ratio of the isocyanate component cross-linking agent to chitosan, based on weight, is preferably 79:21 to 10:90 or even 1:1 to 1:7.

The cross-linking agent can optionally comprise additional polyisocyanate to the mixture of two or more di- or poly-isocyanates. The additional cross-linking agent can be an aliphatic or aromatic monomer, oligomer or prepolymer, usefully of two or more isocyanate functional groups Additional crosslinking agents of the isocyanate type, for example, can be selected from aromatic toluene diisocyanate and its derivatives used in wall formation for capsules, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate, polyisocyanurate of toluene diisocyanate, a trimethylol propane adduct of toluene diisocyanate, toluene diisocyanate, tetramethylxylidene diisocyanate, naphthalene-1,5-diisocyanate, phenylene diisocyanate, 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. The additional isocyanates useful in the invention comprise isocyanate monomers, oligomers or prepolymers, or dimers or trimers thereof, having at least two isocyanate groups. Optimal cross-linking can be achieved with isocyanates having at least three functional groups. This listing is illustrative and not intended to be limiting.

Additional crosslinking agents of the isocyanate type can be formed from adducts of polyisocyanates. An adduct is the product of a molecule with itself and/or with another molecule. In the case of adducts of polyisocyanates with themselves, the isocyanate moieties of the polyisocyanate molecule can react with each other, forming a larger polyisocyanate product containing biuret, uretdione, and/or isocyanurate moieties. In the case of polyol adducts of polyisocyanates, the isocyanate moieties of the polyisocyanate molecule can react with the hydroxyl moieties of a polyol, forming a larger polyisocyanate product containing urethane moieties. In the case of polyamine adducts of polyisocyanates, the isocyanate moieties of the polyisocyanate molecule can react with the amine moieties of a polyamine, forming a larger polyisocyanate product containing urea moieties. In the case of polyacid adducts of polyisocyanates, the isocyanate moieties of the polyisocyanate molecule can react with the carboxylic moieties of a polyacid, forming a larger polyisocyanate product containing anhydride moieties. Where a polyisocyanate is a molecule containing 2 or more isocyanate moieties.

Without wishing to be bound by theory, it is believed that the mixed isocyanate system according to the present invention makes the shell less hygroscopic due to the choice of the two specific isocyanates. The shell comprising one of the isocyanates only does not provide the benefit of reduced leakage.

To create the capsules a water phase is prepared, comprising a water solution or dispersion of an amine-containing natural material having free amino moieties. The amine containing natural material is a bio-based material. Such materials for example include chitosan. The amine-containing natural material is dispersed in water. In the case of chitosan, the material, in embodiments, can even be hydrolyzed thereby protonating at least a portion of the amine groups and facilitating dissolving in water. Hydrolysis is carried out with heating for a period at an acidic pH such as about 3 to about 6.5, or even about 5 or 5.5.

The oil phase is prepared by dissolving the isocyanate component in oil at 25° C. Diluents, for example isopropyl myristate, may be used to adjust the hydrophilicity of the oil phase. The oil phase is then added into the water phase and milled at high speed to obtain a targeted size. The emulsion is then cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the capsules. The slurry is then cooled to room temperature.

Volume weighted median particle size of capsules according to the invention can range from 5 microns to 150 microns, or even from 10 to 50 microns, preferably 15 to 50 microns.

The cross-linking agent of the invention is a mixture or bi- or poly-functional isocyanates. When referring to useful cross-linking agents reference to polyisocyanate should be understood for purposes hereof as inclusive of isocyanate monomer, isocyanate oligomer, isocyanate prepolymer, or dimer or trimer of an aliphatic or aromatic isocyanate. All such monomers, prepolymers, oligomers, or dimers or trimers of aliphatic or aromatic isocyanates are intended by the term “polyisocyanate” as used herein.

The capsule shell could also be reinforced using additional co-crosslinkers such as multifunctional amines and/or polyamines such as diethylene triamine (DETA), polyethylene imine, and polyvinyl amine.

The shell may also be reinforced using additional co-crosslinkers such as multifunctional amines and/or polyamines, such as diethylene triamine (DETA), polyethylene imine, polyvinyl amine, or mixtures thereof. Acrylates may also be used as additional co-crosslinkers, for example to reinforce the shell.

The polymeric material may be formed in a reaction, where the weight ratio of the chitosan present in the reaction to the cross-linker present in the reaction is from about 1:10 to about 1:0.1. It is believed that selecting desirable ratios of the biopolymer to the cross-linking agent can provide desired ductility benefits, as well as improved biodegradability. It may be preferred that at least 21 wt % of the shell is comprised of moieties derived from chitosan, preferably from acid-treated chitosan. Chitosan as a percentage by weight of the shell may be from about 21% up to about 95% of the shell. The ratio of chitosan in the water phase as compared to the isocyanate in the oil phase may be, based on weight, from 21:79 to 90:10 or even from 1:1 to 7:1. The shell may comprise chitosan at a level of 21 wt % or even greater, preferably from about 21 wt % to about 90 wt %, or even from 21 wt % to 85 wt %, or even 21 wt % to 75 wt %, or 21 wt % to 55 wt % of the total shell being chitosan. The chitosan of this paragraph may optionally be acid-treated chitosan or treated with a redox initiator such as persulfate or both.

Chitosan may be added into water in a jacketed reactor and optionally pre-treated with one or both of redox initiator or at a pH from 3 to 6.5, adjusted using an acid (such as one or more of HCl, formic acid or acetic acid). The optional pretreatment step can be accomplished by heating to elevated temperature, such as 85° C. in 60 minutes, and then holding at this temperature from 1 minute to 1440 minutes or longer. The water phase then may be cooled to 25° C. Optionally, a deacetylating step may be added to further facilitate or enhance depolymerization or deacetylation of the chitosan such as by enzymes. An oil phase is prepared by dissolving a mixture of isocyanates, comprising an aromatic moiety, in oil at 25° C. Diluents, for example isopropyl myristate, may be used to adjust the hydrophobicity of the oil phase. The oil phase may then be added into the water phase and milled at high speed to obtain a targeted size. The emulsion may then be cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion may be heated to 85° C. in 60 minutes and then held at 85° C. for 360 minutes to cure the particles. The slurry may then be cooled to room temperature.

The shell may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The capsules (herein also referred to as “delivery particles”) may consist of one or more distinct populations. The composition may have at least two different populations of capsules that vary in the exact make-up of the perfume oil and in the median particle size and/or partitioning modifier to perfume oil (PM:PO) weight ratio. The laundry treatment composition may include more than two distinct populations that vary in the exact make up the perfume oil and in their fracture strengths. The populations of capsules can vary with respect to the weight ratio of the partitioning modifier to the perfume oil(s). The laundry treatment composition can include a first population of capsules having a first ratio that is a weight ratio of from 2:3 to 3:2 of the partitioning modifier to a first perfume oil and a second population of capsules having a second ratio that is a weight ratio of less than 2:3 but greater than 0 of the partitioning modifier to a second perfume oil.

Each distinct population of capsules may be prepared in a distinct slurry. For example, the first population of capsules can be contained in a first slurry and the second population of capsules contained in a second slurry. It is to be appreciated that the number of distinct slurries for combination is without limit and a choice of the formulator such that 3, 10, or 15 distinct slurries may be combined. The first and second populations of capsules may vary in the exact makeup of the benefit agent, such as the perfume oil, and in the median particle size and/or PM:PO weight ratio.

### Core

The core may comprise from about 5% to about 100%, by weight of the core, of a perfume. The core may comprise from about 45% to about 95%, preferably from about 50% to about 80%, more preferably from about 50% to about 70%, by weight of the core, of the perfume.

The perfume may comprise an aldehyde-comprising benefit agent, a ketone-comprising benefit agent, or a combination thereof. Such aldehyde- or ketone-containing perfume raw materials, are known to provide preferred benefits, such as freshness benefits. The perfume may comprise at least about 20%, preferably at least about 25%, more preferably at least about 40%, even more preferably at least about 50%, by weight of the perfume, of aldehyde-containing benefit agents, ketone-containing benefit agents, or combinations thereof.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail in U.S. Pat. No. 6,869,923. Suitable Quadrant I, II, III, and IV perfume raw materials are disclosed therein.

Perfume raw materials having a boiling point B.P. lower than about 250° C. and a log P lower than about 3 are known as Quadrant I perfume raw materials. Quadrant I perfume raw materials are preferably limited to less than 30% of the fragrance material.

The perfume may comprise perfume raw materials that have a log P of from about 2.5 to about 4. It is understood that other perfume raw materials may also be present in the fragrance.

### Method of Making the Water-Soluble Unit Dose Article

Those skilled in the art will be aware of known techniques and methods to make the laundry detergent composition and the water-soluble unit dose article.

### Process of Use

A further aspect of the present invention is a process of laundering fabrics comprising the steps of diluting between 200 and 3000 fold, preferably between 300 and 2000 fold, the water-soluble unit dose article according to the present invention with water to make a wash liquor, contacting fabrics to be treated with the wash liquor.

The wash liquor may comprise water of any hardness preferably varying between 0 gpg to 40 gpg.

Preferably the wash solution comprises between 0.01 and 100 ppm, preferably between 0.1 and 10 ppm of the water-soluble polymer ex the water-soluble film, especially the polyvinyl alcohol ex the water-soluble film, and between 1 and 1000 ppm preferably between 10 and 100 ppm of the capsules. The capsules and the water-soluble polymer ex the water-soluble film, especially the polyvinyl alcohol ex the water-soluble film are preferably in a weight ratio of from 1:1 to 100:1, preferably from 10:1 to 50:1 in the wash solution.

### Test Methods

It is understood that the test methods disclosed in the Test Methods section of the present application should be used to determine the respective values of the parameters of Applicant's claimed subject matter as claimed and described herein.

### Determination of a Polymer's Molecular Weight and Related Parameters

The following method describing gel permeation chromatograph with multi-angle light scatter and refractive index detection (GPC-MALS/RI) is used to find molecular weight distribution measurements and related values of the polymers described herein. Gel Permeation Chromatography (GPC) with Multi-Angle Light Scattering (MALS) and Refractive Index (RI) Detection (GPC-MALS/RI) permits the measurement of absolute molecular weight of a polymer without the need for column calibration methods or standards. The GPC system allows molecules to be separated as a function of their molecular size. MALS and RI allow information to be obtained on the number average (Mn) and weight average (Mw) molecular weight.

The Mw distribution of water-soluble polymers like chitosan is typically measured by using a Liquid Chromatography system (e.g., Agilent 1260 Infinity pump system with OpenLab Chemstation software, Agilent Technology, Santa Clara, CA, USA) and a column set (e.g., 2 Tosoh TSKgel G6000WP 7.8×300 mm 13 um pore size, guard column A0022 6 mm×40 mm PW xl-cp, King of Prussia, PA) which is operated at 40° C. The mobile phase is 0.1M sodium nitrate in water containing 0.02% sodium azide and 0.2% acetic acid. The mobile phase solvent is pumped at a flow rate of 1 mL/min, isocratically. A multiangle light scattering (18-Angle MALS) detector DAWN® and a differential refractive index (RI) detector (Wyatt Technology of Santa Barbara, Calif., USA) controlled by Wyatt Astra® software v8.0 are used.

A sample is typically prepared by dissolving chitosan materials in the mobile phase at ˜1 mg per ml and by mixing the solution for overnight hydration at room temperature. The sample is filtered through a 0.8 m Versapor membrane filter (PALL, Life Sciences, NY, USA) into the LC autosampler vial using a 3-ml syringe before the GPC analysis.

A dn/dc value (differential change of refractive index with concentration, 0.15) is used for the number average molecular weight (Mn), weight average molecular weight (Mw), Z-average molecular weight (Mz), molecular weight of the peak maxima (Mp), and polydispersity (Mw/Mn) determination by the Astra detector software.

### Test Method for Determining Log P

The value of the log of the Octanol/Water Partition Coefficient (log P) is computed for each material (e.g., each PRM in the perfume mixture) being tested. The log P of an individual material (e.g., a PRM) is calculated using the Consensus log P Computational Model, version 14.02 (Linux) available from Advanced Chemistry Development Inc. (ACD/Labs) (Toronto, Canada) to provide the unitless log P value. The ACD/Labs' Consensus log P Computational Model is part of the ACD/Labs model suite.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, California, U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the desired volume-weighted particle size (e.g., the median/50^{th} percentile, 5^{th} percentile, and/or 90^{th} percentile) are determined.

The broadness index can be calculated by determining the particle size at which 95% of the cumulative particle volume is exceeded (95% size), the particle size at which 5% of the cumulative particle volume is exceeded (5% size), and the median particle size (50% size−50% of the particle volume both above and below this size). Broadness Index=((95% size)−(5% size)/50% size).

### Procedure for Determination of % Degradation

% degradation is determined by the “OECD Guideline for Testing of Chemicals” 301B CO₂ Evolution (Modified Sturm Test), adopted 17 Jul. 1992. For ease of reference, this test method is referred to herein as test method OECD 301B.

### Perfume Leakage

The amount of perfume leakage from the perfume containing capsule is determined according to the following method:
i) Obtain two 1 g samples of perfume containing capsules.
ii) Add 1 g of perfume containing capsules to 99 g of the detergent matrix in which the capsules will be employed and label the mixture as Sample 1. Immediately use the second 1 g sample of perfume containing capsules in Step d below, in its neat form without contacting detergent matrix, and label it as Sample 2.
iii) Age the capsule-containing detergent matrix (Sample 1) for 1 week at 35° C. in a sealed glass jar.
iv) Using filtration, recover the capsules from both samples. The capsules in Sample 1 (in detergent matrix) are recovered after the aging step. The capsules in Sample 2 (neat raw material slurry) are recovered at the same time that the aging step began for sample 1.
v) Treat the recovered capsules with a solvent to extract the perfume from the particles.
vi) Analyze the solvent containing the extracted perfume from each sample, via chromatography.
vii) Integrate the resultant perfume peak areas under the curve and sum these areas to determine the total quantity of perfume extracted from each sample.
viii) Determine the percentage of perfume leakage by calculating the difference in the values obtained for the total quantity of perfume extracted from Sample 2 (S2) minus Sample 1 (S1), expressed as a percentage of the total quantity of perfume extracted from Sample 2 (s2), as represented in the equation below:

$$\% Leakage = ( \frac{S 2 - S 1}{S 2} ) \times 100$$

### Method to Determine Headspace Concentration Above Treated Dry Fabrics.

Miele washing machines were used to treat the fabrics. For each treatment, the washing machine was loaded with 3 kg fabric, comprising 1100 g knitted cotton fabric, 1100 g polyester-cotton fabrics (50/50). Additionally, 18 terry towel cotton tracers are also added, which weight together about 780 g.

Prior to the test treatment, the load is preconditioned twice, each time using the 95° C. short cotton cycle with 79 g of unperfumed IEC A Base detergent (ex WFK Testgewebe GmbH), followed by two additional 95° C. washes without detergent.

For the test treatment, the load is washed using a 30° C. short cotton cycle, 1400 rpm spin speed with 20.6 g of Unit Dose Article which was previously aged for 4 weeks at 35° C. in a sealed glass jar.

At the end of the treatment cycle, the terry towel tracers are removed from the washing machine. Wet terry towel tracers are either analyzed by fast headspace GC/MS (gas chromatography mass spectrometry) approach, as described below and line-dried overnight. The next day, the dry terry towel tracers are analyzed by fast headspace GC/MS (gas chromatography mass spectrometry) approach, as described below. All treatments washed at the same day for comparative purpose and analyzed on the same day are reported as “one wash test.”

The fabric tracers from the abovementioned Fabric Treatment method are analyzed via headspace analysis at least three specific touchpoints:
WFO (Wet Fabric Odor, or WET): Wet fabrics are analyzed after the fabric treatment method is finished.
DFO (Dry Fabric Odor, or DRY): Dried Fabrics are analyzed after the fabrics have been line-dried in a closed room for approximately twenty-four hours.
RFO (Rub Fabric Odor): Dried Fabrics are placed into the 25 ml headspace vial and are compressed with a weighted rod (total weight 3.62 kg, 4.62 bar) for 10 seconds, afterwards the vial is left for 10 seconds without compression after which the vial is closed.

The headspace above the cotton terry tracers is analyzed using SPME headspace GC/MS (gas chromatography mass spectrometry) approach. 4 cm×4 cm aliquots of cotton tracers are transferred to 25 ml headspace vials. The fabric samples are equilibrated for 10 minutes at 65° C. The headspace above the fabrics is sampled via SPME (50/30 m DVB/Carboxen/PDMS) for 5 minutes. The SPME fiber is subsequently on-line thermally desorbed into the GC. The analytes are analyzed by GC/MS in full scan mode. The total perfume HS response and perfume headspace composition above the tested legs can be determined.

### % NCO Groups

The % NCO groups of isocyanate compounds is calculated as below equation:

$$\% NCO = \frac{Number of NCO groups \cdot MW NCO group}{MW Isocyanate compound}$$

Where Number of NCO groups is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.

When isocyanate is used as a mixture of multiple isocyanates, the % NCO groups is reported as the weighted sum of mass percentages for each individual isocyanate within the mixture.

All temperatures herein are in degrees Celsius (° C.) unless otherwise indicated. Unless otherwise specified, all measurements herein are conducted at 20° C. and under the atmospheric pressure.

All percentages and ratios are calculated by weight unless otherwise indicated. All percentages and ratios are calculated based on the total composition unless otherwise indicated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Examples

In the following examples, the abbreviations, materials or tradenames correspond to the materials listed in Table 1 and Table 2. The examples are intended to be illustrative in nature and are not intended to be limiting.

Table 1 describes the chitosan material used to create the perfume capsules tested.

TABLE 1
Materials - chitosan

| Trade Name | Company/City | Material |
|---|---|---|
| ChitoClear | Primex EHF, Siglufjordur, Iceland | chitosan |

Table 2 describes the isocyanate materials used to create the perfume capsules to be tested.

TABLE 2
Materials-isocyanate

| Trade | Company/ | | | Classifica- | % NCO |
|---|---|---|---|---|---|
| Name | City | Material | Chemical structure | tion | groups |
| Takenate D-110N | Mitsui Chemicals America, Inc., Rye Brook, NY | polyisocyanate prepolymer; adduct of xylylene diisocyanate | 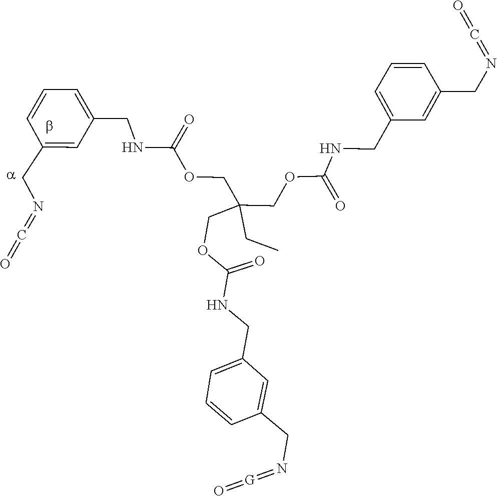 | Beta- Aromatic | 15.3% |
| MMRL Mondur MR-Light | Covestro LLC Pittsburgh, PA | polymeric diphenyl- methane diisocyanate | 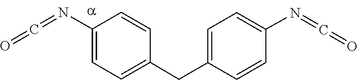 [SMILES: O=C=Nc1ccc(Cc2ccc(N=C=O)cc2)cc1] | Alpha- Aromatic | 31.3% |
| | | | 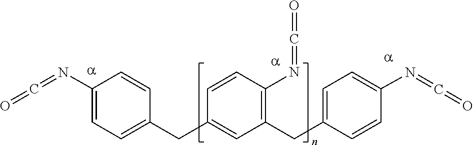 | | |

### Perfume Leakage in Unit Dose Article

Perfume leakage in a unit-dose article, containing the detergent composition detailed in Table 5, was assessed according to the method “Perfume Leakage” provided in the Test Methods section above. The data in Table 3 demonstrate that samples made with all beta-aromatic isocyanate (Comparative Example 1) or all alpha-aromatic isocyanate (Comparative Example 2) show the highest level of leakage when formulated into a water-soluble unit dose article, wherein the water-soluble unit dose article comprising a liquid laundry treatment composition, wherein said liquid laundry treatment composition comprised less than 15 wt % of water. When a combination of alpha- and beta-aromatic isocyanates are used according to the invention, a lower level of leakage is observed in said unit dose articles.

TABLE 3

| | | | | | | | Leakage in | |
|---|---|---|---|---|---|---|---|---|
| | Beta-aromatic Isocyanate | | | Alpha-aromatic Isocyanate | | | Unit Dose | Weighted |
| Example | Name | Amount (g) | % | Name | Amount (g) | % | article % | NCO % |
| Comparative | Takenate D- | 4.81 | 100 | Mondur MR- | 0 | 0 | 13.5 ± 0.7 | 15.3 |
| Example 1 | 110N | | | Light | | | | |
| Example 1A | Takenate D- | 4.55 | 94.6 | Mondur MR- | 0.2 | 5.4 | 9.4 ± 0.4 | 16.2 |
| | 110N | | | Light | | | | |
| Example 1B | Takenate D- | 4.08 | 84.8 | Mondur MR- | 0.55 | 15.2 | 7.1 ± 0.1 | 17.7 |
| | 110N | | | Light | | | | |
| Example 1C | Takenate D- | 3.61 | 75 | Mondur MR- | 0.9 | 25 | 5.6 ± 0.1 | 19.3 |
| | 110N | | | Light | | | | |
| Example 1D | Takenate D- | 2.62 | 65.2 | Mondur MR- | 1.01 | 34 | 2.2 ± 0.6 | 20.7 |
| | 110N | | | Light | | | | |
| Example 1E | Takenate D- | 2.08 | 52.5 | Mondur MR- | 1.41 | 47.5 | 2.0 ± 0.1 | 22.9 |
| | 110N | | | Light | | | | |
| Example 1F | Takenate D- | 1.54 | 38.75 | Mondur MR- | 1.82 | 61.3 | 2.9 ± 0.1 | 25.1 |
| | 110N | | | Light | | | | |
| Comparative | Takenate D- | 0 | 0 | Mondur MR- | 2.97 | 100 | 18.7 ± 0.1 | 31.3 |
| Example 2 | 110N | | | Light | | | | |

All samples of Table 4 are made with the same weight concentration 66% for Isocyanate 1 and 34% for Isocyanate 2. As illustrated in Table 4, capsules using a combination of aromatic isocyanates according to the invention achieve lower leakage when formulated in water-soluble unit dose articles, wherein the water-soluble unit dose article comprising a liquid laundry treatment composition, wherein said liquid laundry treatment composition comprised less than 15 wt % of water and 1% by weight of the liquid laundry treatment composition of the capsule.

TABLE 4

| | Isocyanate 1 | | | | Isocyanate 2 | | | | Leakage in |
|---|---|---|---|---|---|---|---|---|---|
| | | | % of | Amount | | | % of | Amount | Unit Dose |
| Example # | Name | Classification | Isocyanate | (g) | Name | Classification | Isocyanate | (g) | article % |
| Comparative | Takenate D- | Beta- | 66 | 3.22 | Wannate | No aromatic | 34 | 1.24 | 31.3 ± 0.5 |
| example 3 | 110N | aromatic | | | H1210 | | | | |
| Comparative | Takenate D- | Beta- | 66 | 3.22 | Desmodur N | No aromatic | 34 | 1.24 | 15.7 ± 0.1 |
| example 4 | 110N | aromatic | | | 3400 | | | | |
| Comparative | Takenate D- | Beta- | 66 | 3.22 | Desmodur N | No aromatic | 34 | 1.24 | 21.4 ± 0.2 |
| example 5 | 110N | aromatic | | | 3300, | | | | |
| Example 1D | Takenate D- | Beta- | 66 | 2.62 | Mondur MR- | Alpha- | 34 | 1.01 | 2.2 ± 0.6 |
| | 110N | aromatic | | | Light | aromatic | | | |
| Example 1 G | Takenate D- | Beta- | 66 | 3.22 | Lupranate M20 | Alpha- | 34 | 1.24 | 3.65 ± 0.1 |
| | 110N | aromatic | | | Isocyanate | aromatic | | | |

### Headspace Perfume Concentration Above Treated Fabrics

Fabrics were treated with a unit-dose article, comprising the detergent composition detailed in Table 5, according to the Fabric Treatment Method provided in the Test Methods section above (via the “Method to determine headspace concentration above treated fabrics”).

According to the data in Table 4, the comparative example 1 comprising capsules based on a single isocyanate shows no DFO and RFO Headspace benefit, while Example 1D comprising capsules based on a mix of an alpha and a beta aromatic isocyanate displays significant higher headspace values at DFO and RFO. It is believed that the benefit of Example 1D compared to the comparative example 1 is due to the optimal combination of beta-aromatic isocyanate and alpha-aromatic isocyanate which leads to a lower perfume leakage in a unit dose article as highlighted in Table 3, which subsequently leads to higher Headspace Concentration above dry (DFO) and rubbed (RFO) fabrics.

TABLE 4
Perfume headspace analysis

| | Beta-aromatic | | | Alpha-aromatic | | | | | |
|---|---|---|---|---|---|---|---|---|---|
| | Isocyanate | | | Isocyanate | | | | | |
| | | Amount | | | Amount | | WFO HS | DFO HS | RFO HS |
| Example | Name | (g) | % | Name | (g) | % | [nmol/L] | [nmol/L] | [nmol/L] |
| Comparative | Takenate | 4.81 | 100 | Mondur | 0 | 0 | 18.2 ± 1.3 | 0 ± 0 | 0 ± 0 |
| Example 1 | D-110N | | | MR-Light | | | | | |
| Example 1A | Takenate | 2.62 | 65.2 | Mondur | 1.01 | 34 | 71.7 ± 9.0 | 4.6 ± 0.9 | 8.4 ± 0.7 |
| | D-110N | | | MR-Light | | | | | |

### Detergent Composition in Unit Dose Article

The following is an exemplary water-soluble unit dose base formulation, prepared through mixing of the individual starting materials in a batch type process. The below composition can be enclosed in a water-soluble film, preferably a polyvinyl alcohol based water soluble film, more specifically a water soluble film comprising a blend of a polyvinylalcohol homopolymer and a carboxylated anionic polyvinylalcohol copolymer, alternatively a blend of polyvinylalcohol homopolymers, alternatively a water soluble film comprising a carboxylated anionic polyvinylalcohol copolymer such as M8630 or M8310 ex the MonoSol company, alternatively a combined use thereof.

TABLE 5
Liquid detergent composition

| | Composition (wt % |
|---|---|
| Ingredients | as 100% active) |
| Fatty alcohol ethoxylate non-ionic surfactant, | 3.5 |
| C₁₂₋₁₄ average degree of ethoxylation of 7 | |
| Linear C₁₁₋₁₄ alkylbenzene sulphonate | 27.3 |
| C12-14 AE3S Ethoxylated alkyl sulphate with | 11.07 |
| an average degree of ethoxylation of 3 | |
| Citric acid | 0.7 |
| Palm Kernel Fatty acid | 5.4 |
| Protease enzyme | Present |
| Amylase enzyme | Present |
| Xyloglucanase enzyme | Present |
| Mannanase enzyme | Present |
| Nuclease enzyme* | Present |
| Ethoxylated polyethyleneimine** | 1.6 |
| Amphiphilic graft copolymer*** | 3.2 |
| Zwitterionic polyamine**** | 1.9 |
| HEDP chelant | 2.3 |
| Brightener 49 | 0.3 |
| Silicone anti-foam | 0.3 |
| 1,2 PropaneDiol | 13.0 |
| Glycerine | 5.5 |
| DPG (DiPropyleneGlycol) | 0.001 |
| Sorbitol | 0.1 |
| Monoethanolamine | 10.53 |
| K2SO3 | 0.15 |
| MgCl2 | 0.3 |
| Sodium formate | 0.1 |
| water | 10.6 |
| Hydrogenated castor oil | 0.1 |
| Free perfume | absent |
| Aesthetic dye & Minors (preservatives, | Balance to 99.0 |
| salts, . . .) | |
| Hole for perfume capsule test formulations | 1.0 |
| pH (10% product concentration in | 7.4 |
| demineralized water at 20° C.) | |

*Nuclease enzyme is as claimed in co-pending European application 19219568.3
**Lutensol FP620 ex BASF - ethoxylated polyethyleneimine (PEI600 EO20)
***polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
****Lutensit Z96 (zwitterionic polyamine ex BASF - zwitterionic hexamethylene diamine according to below formula: 100% quaternized and about 40% of the polyethoxy (EO24) groups are sulfonated).

What is claimed is:

1. A water-soluble unit dose article, wherein the water-soluble unit dose article comprises a water-soluble film and a laundry detergent composition, wherein the water-soluble film encloses the laundry detergent composition, wherein the laundry detergent composition comprises capsules, wherein the capsules have a core and a shell and wherein the shell surrounds the core;
wherein the core comprises a perfume,
wherein the shell comprises a polymeric material that is the reaction product of chitosan and a cross-linking agent,
wherein the cross-linking agent comprises an isocyanate component, the isocyanate component comprising a mixture of two or more di- and/or poly-isocyanates, the di- and/or poly-isocyanates each comprising an aromatic moiety; and,
wherein the mixture of di- and/or poly-isocyanates comprising an aromatic moiety comprises at least one alpha-aromatic isocyanate and at least one beta-aromatic isocyanate.

2. A water-soluble unit dose article according to claim 1, wherein the weighted % NCO groups of the di- and/or poly-isocyanates comprising an aromatic moiety within the isocyanate component is from about 15 to about 32% by weight, and wherein;
the % NCO groups of isocyanate compounds is calculated as below equation:
$$\% NCO = \frac{Number of NCO groups \cdot MW NCO group}{MW isocyanate compound}$$
where Number of isocyanate groups (NCO groups) is the count of isocyanate groups present in the compound, MW NCO group is the molecular weight of a single NCO group, MW isocyanate compound is the molecular weight of the entire isocyanate compound, excluding any solvent or other substances that may be mixed with the isocyanate.

3. A water-soluble unit dose article according to claim 1 wherein the mass percent of the alpha-aromatic isocyanate in the isocyanate component is from about 1 to about 99% by weight, by weight of the isocyanate component.

4. A water-soluble unit dose article according to claim 1 wherein the mass percent of the beta-aromatic isocyanate in the isocyanate component is from about 1 to about 99% by weight, by weight of the isocyanate component.

5. A water-soluble unit dose article according to claim 1 wherein the alpha-aromatic isocyanate is selected from the group consisting of: 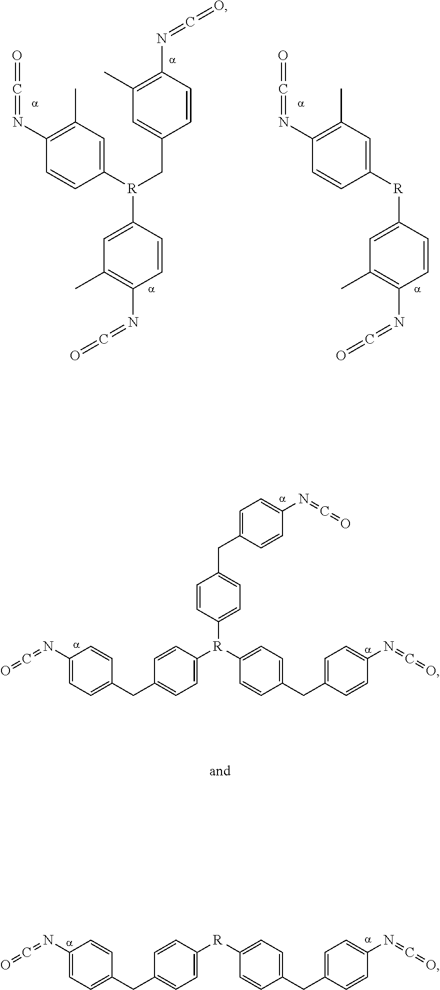
wherein R is a biuret, a uretdione, an isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
wherein the alpha-aromatic isocyanate is selected from the group consisting of: 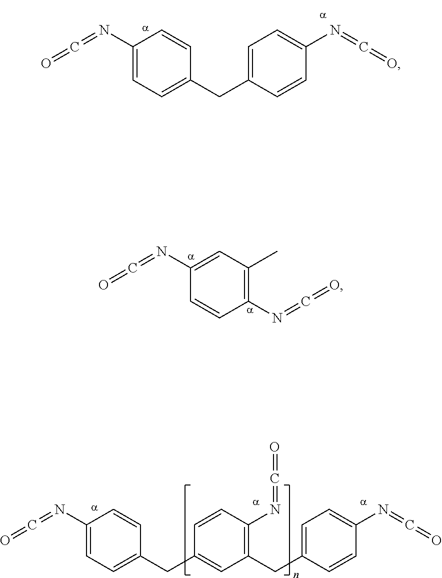
(wherein n is an integer from 1 to 24, 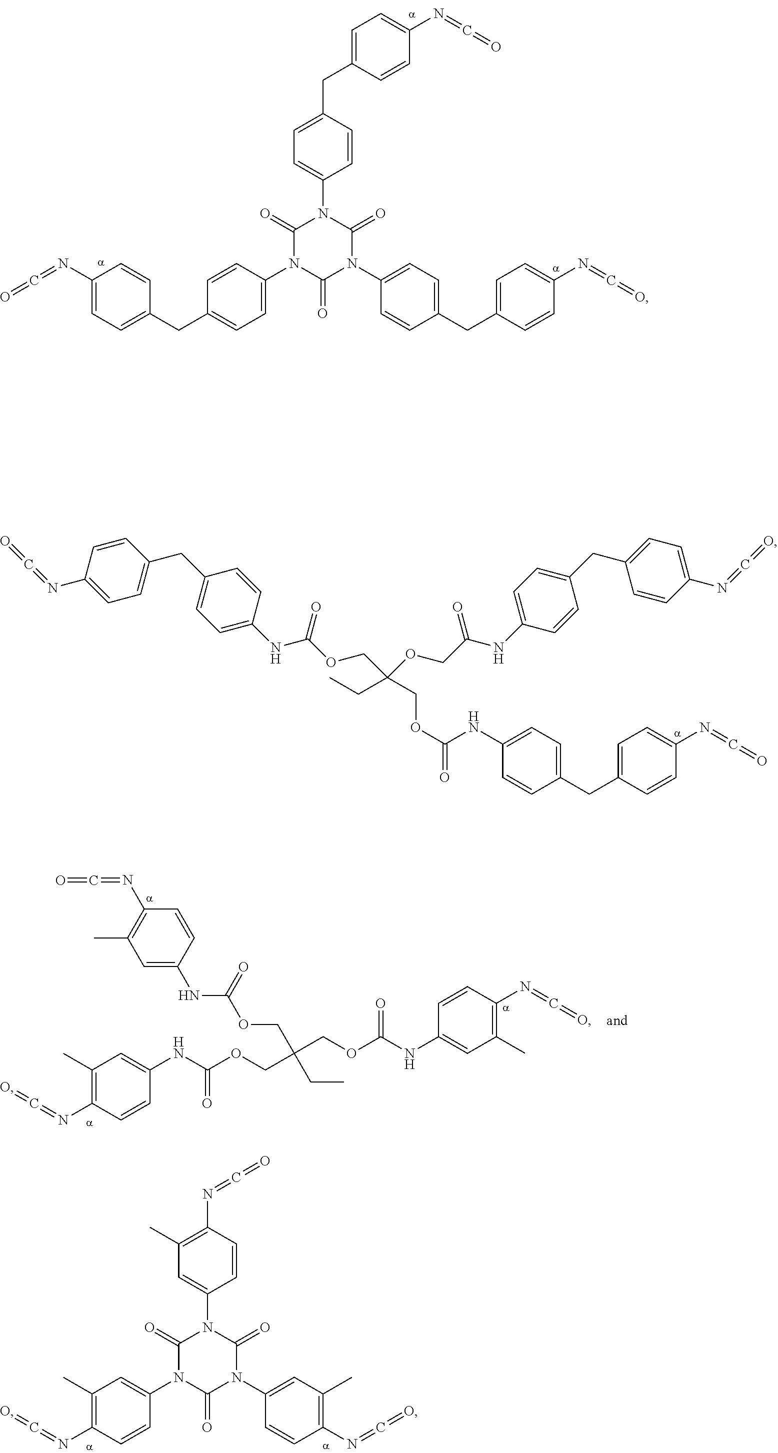 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]
wherein the alpha-aromatic isocyanate is selected from the group consisting of toluene diisocyanate, methylene diphenyl diisocyanate, polymeric methylene diphenyl diisocyanate, naphthalene diisocyanate, phenylene diisocyanate, isomers thereof, adducts thereof, and combinations thereof.

6. A water-soluble unit dose article according to claim 1 wherein the beta-aromatic isocyanate is selected from the group consisting of: 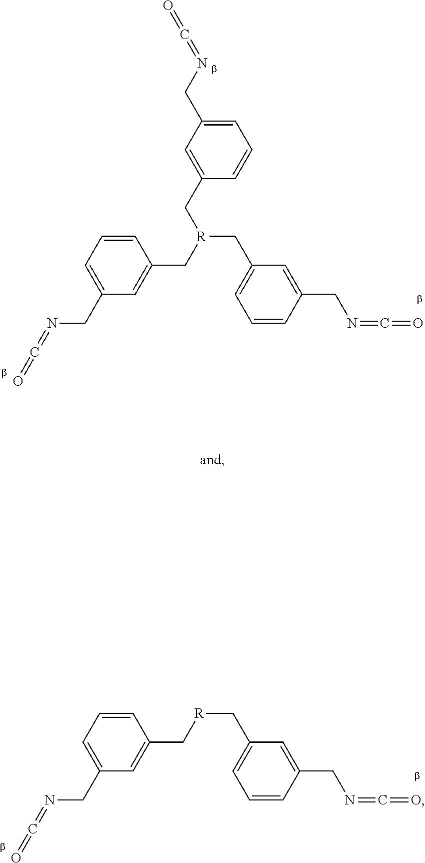
wherein R is a biuret, a uretdione, an isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate.

7. A water-soluble unit dose article according to claim 1, wherein the isocyanate component comprises at least two di- and/or poly-isocyanates selected from methylenediphenyl diisocyanate, polymeric methylenediphenyl isocyanate, and a trimethylol propane-adduct of xylylene diisocyanate, wherein the isocyanate component comprises methylenediphenyl isocyanate, polymeric methylenediphenyl isocyanate, and a trimethylol propane-adduct of xylylene diisocyanate in a weight ratio of from about 1:2 to about 1:1.75, or wherein the isocyanate component comprises by weight about 30 to about 40%, about 34% of a combination of methylenediphenyl isocyanate and polymeric methylenediphenyl isocyanate and from about 60 to about 70%, or about 66% of a trimethylol propane-adduct of xylylene diisocyanate.

8. A water-soluble unit dose article according to claim 1, wherein the chitosan, is characterized by a weight average molecular weight of from about 100 kDa to about 800 kDa.

9. A water-soluble unit dose article according to claim 1, wherein the ratio of the cross-linking agent to chitosan, based on weight, is about 79:21 to 1 about 0:90.

10. A water-soluble unit dose article according to claim 1, wherein the core-shell capsules have a ratio of core to shell of at least about 75:25, on the basis of weight.

11. A water-soluble unit dose article according to claim 1, wherein the perfume comprises perfume raw materials characterized by a log P of from about 2.5 to 4.5.

12. A water-soluble unit dose article according to claim 1 wherein the capsules have a median particle size of from about 1 to about 200 microns.

13. A water-soluble unit dose article according to claim 1, wherein the laundry detergent composition comprises the capsules in an amount from about 0.05% to about 20% by weight of the laundry detergent composition.

14. A water-soluble unit dose article according to claim 1, wherein the laundry detergent composition is a liquid laundry detergent composition comprising between about 1% and about 20% by weight of the liquid laundry detergent composition of water.

15. A water-soluble unit dose article according to claim 1, wherein the laundry detergent composition comprises non-encapsulated perfume.

16. A water-soluble unit dose article according to claim 1, wherein the water-soluble film comprises a polyvinylalcohol homopolymer, a polyvinylalcohol copolymer or a blend thereof, a blend of polyvinylalcohol homopolymers and/or anionic polyvinylalcohol copolymers, wherein the polyvinylalcohol copolymers are selected from sulphonated and carboxylated anionic polyvinylalcohol copolymers especially carboxylated anionic polyvinylalcohol copolymers, or the water-soluble film comprises a blend of a polyvinylalcohol homopolymer and a carboxylated anionic polyvinylalcohol copolymer or a blend of polyvinylalcohol homopolymers.

17. A water-soluble unit dose article according to claim 1, wherein the capsules have been dried by heating to remove the water.
